(19) United States
(12) Patent Application Publication
(10) Pub. No.: US 2007/0190263 A1
(43) Pub. Date: Aug. 16, 2007

(54) Internal coating technique for non-cylindrical components

(76) Inventors: John Gerard Finch, Livonia, MI (US); Daniel Ford, Ypsilanti, MI (US); Joseph Elmer, Zionsville, IN (US); Tracey Montgomery, Belleville, MI (US); Mike Krushlin, Westland, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/352,027

(22) Filed: Feb. 10, 2006

(51) Int. Cl. B05D 5/12; B05C 5/02

(52) U.S. Cl. 427/476; 118/621; 118/317

(57) ABSTRACT

An electrophoretic coating for a non-cylindrical component, such as a faucet, utilizes a flexible anode and sleeve assembly. The flexible anode and sleeve assembly may be inserted into the interior of the faucet, and can bend around the non-cylindrical shape. The coating may then be applied within the interior of the component.

### BACKGROUND OF THE INVENTION

This application relates to a method and apparatus for providing a coating on the interior surface of a non-cylindrical part, such as a faucet spout.

Electrophoretic coatings (e-coat) are known in the prior art, and are utilized with surfaces that will come into contact with fluids such as potable water. The coatings are intended to prevent leaching of metals from the surfaces of the component as the fluid passes through the components. This is especially true of components containing copper and lead.

Typically, the coatings have been applied in large baths. The coating material is put into the bath, and an anode/cathode creates a charge to cause the coatings to adhere to the surface of the metal component. Faucets would desirably have this coating, however, the use of the bath is undesirably complicated. Also, interior surfaces are not always adequately coated by such a bath.

It is also known to put the anode/cathode within the interior of the component, and coat only the interior of the component. However, known methods have typically been utilized for cylindrically shaped parts, such as cans. The known apparatus for coating a cylindrical part has utilized a relatively rigid anode extending along an axis parallel to the cylindrical part.

Thus, the coating of the inner surface of a faucet spout, or other non-cylindrical parts, has proven challenging. Moreover, faucet spouts, and potentially other components, have outer coatings for appearance purposes. As an example, a faucet spout may have a chrome plating on its outer surface. It may be desirable to have this plating put onto the faucet spout prior to the e-coat being applied. In such a situation, it would be necessary to keep the e-coat material from contacting any of the chrome-plated surfaces.

For all of these reasons, a method of simply coating the interior surfaces of non-cylindrical components is desirable.

### SUMMARY OF THE INVENTION

In a disclosed embodiment of this invention, an anode has a non-linear shape. In disclosed embodiments, the anode is actually flexible such that it can bend to conform to the non-cylindrical shape of a component to be coated. In one embodiment, an electrode is received within the interior of a plastic tube, and the plastic tube has holes to allow the coating material to contact the electrode. As disclosed, a charge is applied once the electrode is inserted within the component, and such that the electrode is the anode. The component may be a faucet spout. In the disclosed embodiment, the component is grounded such that it provides a cathode. It should be understood that the component could be made the anode, and provided with a positive charge, and the grounded cathode be the electrode that is moved into the interior of the component to be coated. In fact, the internal electrode can be the anode or the cathode as needed, depending on the paint system used.

In various other embodiments, a plurality of cylindrical tube sections with spaced beads, spherical beads or bead-like members, which are non-conductive, may be utilized to surround the electrode and prevent contact with the conductive vessel being coated. In this embodiment, the cylindrical balls will be in point contact with the interior surface of the component. It is desirable to minimize contact between the electrode and cover assembly, and the interior surface to be coated. Each contact point is potentially a location where there would be no coating.

In another embodiment, the plastic tube is formed as a helical wrap around the electrode. Gaps between the wraps allow the coating to contact the electrode during charging.

In other features, the apparatus that holds the component, may be turned during the coating process. This will cause any entrapped air bubbles to shift, such that the location of the air bubbles will change and the entire surface will be coated.

In yet another embodiment, the electrode may be moved within the component during coating. This movement will ensure that any location of contact between the electrode and cover assembly and the interior surface will change such that no point within the interior surface will be in contact with the electrode and its cover during the entire coating process. This will ensure that the entire surface should be adequately coated.

These and other features of the present invention can be best understood from the following specification and drawings, the following of which is a brief description.

### BRIEF DESCRIPTION OF THE DRAWINGS

FIG. 1 shows a first embodiment coating apparatus.

FIG. 2 shows a detail of a portion of the FIG. 1 apparatus.

FIG. 3A shows an alternative apparatus.

FIG. 3B shows the FIG. 3A apparatus at a distinct point in the coating process.

FIG. 4 shows another embodiment.

FIG. 5 shows another embodiment.

### DETAILED DESCRIPTION OF THE PREFERRED EMBODIMENT

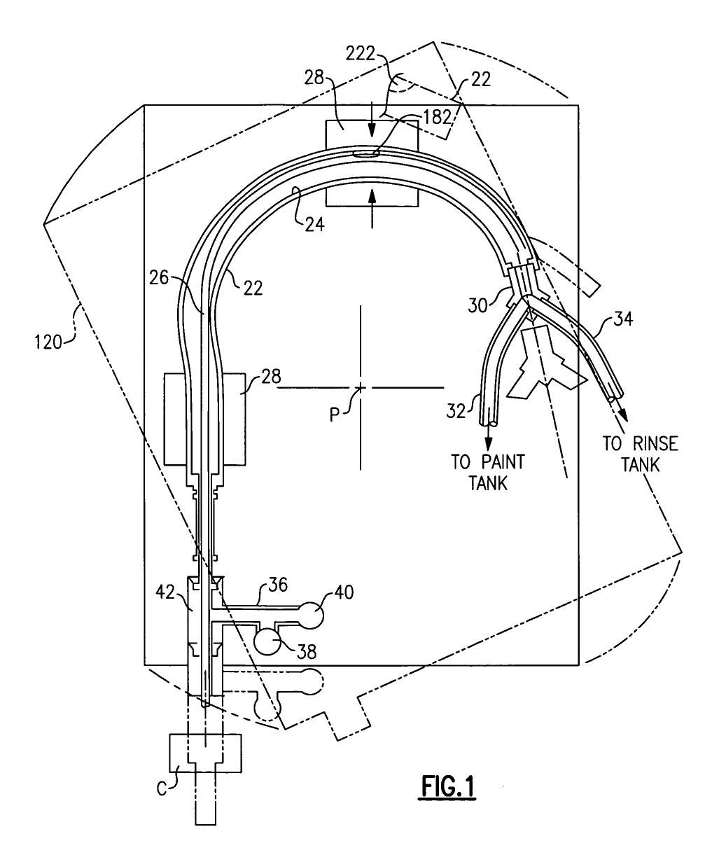

An apparatus 20 for coating the interior of a component such as a faucet spout 22 is shown in FIG. 1. The interior surface 24 is to be provided with an e-coat.

An anode and protective covering assembly 26 is inserted within the interior of the faucet spout 22. Clamps 28 hold the faucet spout on the apparatus 20. Insert plug 30 is inserted at one end of the spout, and may have a drain 32 to a paint (e-coat) tank, and another drain 34 to a rinse tank. Another component 36 is positioned at the other end of the spout. A paint supply line 38 and a rinse supply line 40 may be placed at that end. These fluids flow within a housing component 42 including a seal 44. Paint is inserted into the faucet spout while the anode assembly 26 is within the spout. A charge is placed on the anode and the coating will occur. It is believed helpful for the paint to continue to flow during this process. Once the coating is complete, a rinse may flow within the faucet spout. The rinse may occur prior to the e-coat curing. While not shown, it is preferred that both the paint and rinse include a pump for moving the fluids through the faucet spout 22, and that the pumps pull the respective liquids from the tanks to which the lines 32 and 34 return. That is, the fluids are preferably flowing in a closed loop.

Air bubbles 122 may be within the faucet spout when the coating occurs. As known, the air bubbles will typically migrate to the vertically highest location. Thus, at some point during the component coating, the apparatus 20 is preferably moved to rotate about a pivot point P. As an example, a rotated position is shown at 120. In this rotated position, the air bubbles 122 were moved to a new point 222. If there was any area that was not coated due to the original location of the air bubbles 122, the new location of the air bubbles 222 will ensure that prior location will be coated.

The anode and protective sleeve assembly 126 is shown in FIG. 2. As shown, a flexible plastic tube 50 has a plurality of holes 52 that allow the coating to contact the inner wire 54. A charge is applied to the inner wire 54, such as by a charging apparatus C, shown schematically in FIG. 1. It should be understood that the electrical detail of this invention are known in the art. The control C would typically include a rectifier to provide the electrical charge. The rectifier parameters would be determined based upon the application, and as known with this art. A negative grounding system attaches to the faucet spout 22, such that the faucet spout becomes a cathode. Of course, the flexible assembly 26 may be grounded with the charge applied to the faucet spout 22, such that the faucet spout becomes the anode and the flexible assembly 26 provides the cathode. It is the use of the flexible assembly 26, which allows the coating to be performed within a non-cylindrical component, which is the main inventive feature here.

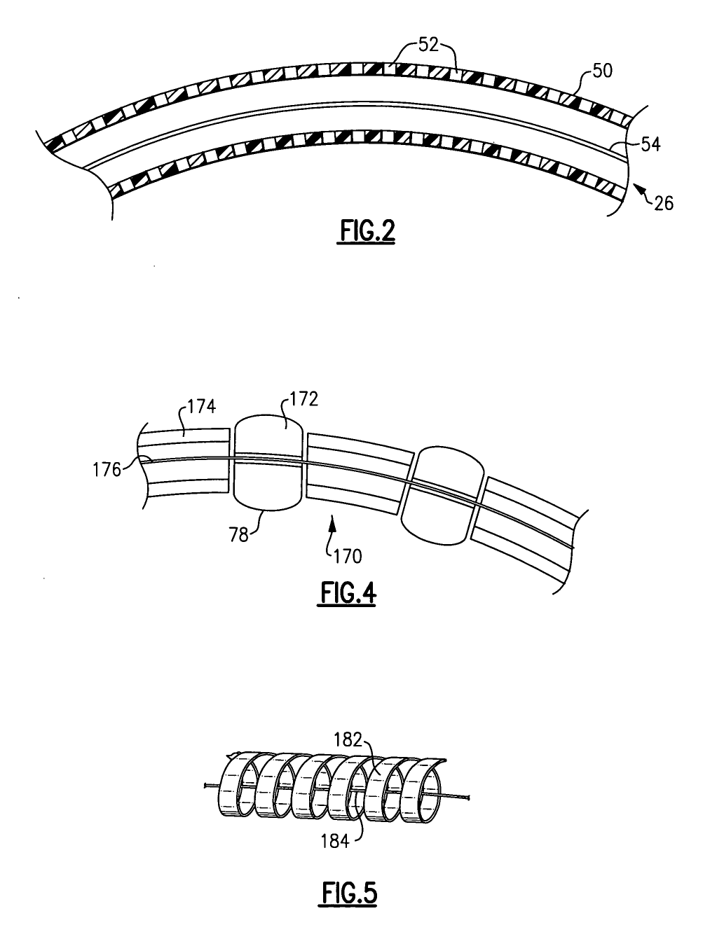

FIG. 3A shows another assembly 60. A plug 62 has an outlet 64 for the paint. The faucet spout 66 has another plug 68 at its opposed end and a paint supply 70. The anode and cover assembly 72 may be similar to that shown in FIG. 2. However, the anode assembly 72 is associated with a moving apparatus 74 which will move during the coating process. Thus, as shown between FIGS. 3A and 3B, the anode is moved while coating occurs. This will ensure that if there is any point of contact such as shown at C in FIG. 3A, that point of contact will change to different locations due to the movement of the anode. Again, this will ensure complete coating.

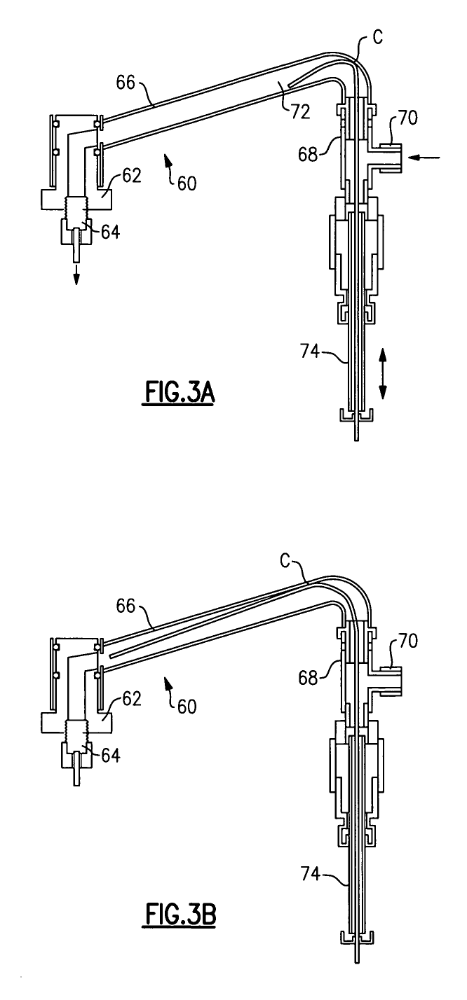

FIG. 4 shows another embodiment 170 wherein non-conductive spherical balls 172 are interspersed with tubular sections 174. The central anode 176 will operate as the earlier embodiments. The segmented balls and sleeve 172 and 174 will allow the anode assembly 170 to bend within the faucet spout.

FIG. 5 shows another embodiment 180 wherein the protective sleeve is a flexible helical spiral 182 surrounding the wire 184. Again, this structure will allow the anode assembly to bend to conform to the inner shape as it is moved within the faucet spout.

Although preferred embodiments of this invention have been disclosed, a worker of ordinary skill in this art would recognize that certain modifications would come within the scope of this invention. For that reason, the following claims should be studied to determine the true scope and content of this invention.

What is claimed is:

1. A method of coating a non-cylindrical component comprising the steps of:
1) mounting a non-cylindrical component onto a fixture;
2) flowing a coating within an interior of said non-cylindrical component, and inserting an assembly of an electrode and a protective outer sleeve into the interior of said component, said assembly being flexible such that it can conform to said non-cylindrical shape; and
3) applying a charge on one of said electrode and said component to cause said coating to adhere to the inner wall of said non-cylindrical component.

2. The method as set forth in claim 1, wherein said non-cylindrical component is a faucet spout.

3. The method as set forth in claim 1, wherein said protective outer sleeve has a cylindrical shape in a non-deformed state, with said cylindrical shape having openings to allow said coating to contact a central wire, said central wire providing said electrode.

4. The method as set forth in claim 1, wherein said protective outer sleeve is a plurality of tubular segments, with interspersed spherical balls, and said electrode extending through an interior surface in each of said tubular segments and said spherical balls.

5. The method as set forth in claim 1, wherein said protective outer sleeve is a helical wrap wrapped around a central wire, said central wire providing said electrode.

6. The method as set forth in claim 1, wherein said fixture is rotated during the coating process to cause any entrapped air bubbles to move.

7. The method as set forth in claim 1, wherein said assembly is moved within said non-cylindrical component during the coating process.

8. The method as set forth in claim 1, wherein a rinse is moved through the interior of said non-cylindrical component after the coating process is completed.

9. The method as set forth in claim 1, wherein said coating is an electrophoretic coating.

10. The method as set forth in claim 1, wherein said electrode is supplied with the charge in step 3).

11. The method as set forth in claim 10, wherein said component is grounded during step 3).

12. The method as set forth in claim 1, wherein said protective outer sleeve is non-conductive.

13. An apparatus for providing a coating to a non-cylindrical component comprising:
a fixture for mounting a non-cylindrical component;
a coating supply;
an assembly of an electrode and protective outer sleeve, said assembly being flexible to conform to a shape of the non-cylindrical component; and
a control to apply a positive electrical charge to one of said electrode and the component to cause the coating to adhere to the inner wall of the component.

14. The apparatus as set forth in claim 13, wherein the non-cylindrical component is a faucet spout.

15. The apparatus as set forth in claim 13, wherein said protective outer sleeve has a cylindrical shape in a non-deformed state, with said cylindrical shape having openings to allow said coating to contact a central wire, and said central wire providing said electrode.

16. The apparatus as set forth in claim 13, wherein said protective outer sleeve is a plurality of tubular segments, with interspersed spherical balls, and said electrode extending through an interior surface in each of said tubular segments and said spherical balls.

17. The apparatus as set forth in claim 13, wherein said protective outer sleeve is a helical wrap wrapped around a central wire.

18. The apparatus as set forth in claim 13, wherein said fixture is rotated during the coating process to cause any entrapped air bubbles to move.

19. The apparatus as set forth in claim 13, wherein said assembly is moved within the said non-cylindrical component during the coating process.

20. The apparatus as set forth in claim 13, wherein a rinse is moved through the interior of the non-cylindrical component after the coating process is completed.

21. The apparatus as set forth in claim 13, wherein said coating is an electrophoretic coating,

22. The apparatus as set forth in claim 13, wherein said electrode is charged.

23. The apparatus as set forth in claim 22, wherein said component is grounded such that it acts as a cathode with said electrode being an anode during the charging.

24. The apparatus as set forth in claim 13, wherein said protective sleeve is relatively non-conductive compared to said electrode.

25. An apparatus for providing a coating to a non-cylindrical component comprising:
a fixture for mounting a non-cylindrical component, said fixture grounding said non-cylindrical component;
an electrophoretic coating supply, including a supply line and a return line for flowing said electrophoretic coating through the non-cylindrical component during a coating process;
an anode with a protective outer sleeve, said anode and protective outer sleeve being flexible to conform to a shape of the non-cylindrical component, said protective sleeve being less conductive than said anode; and
a control to apply a positive charge to said anode, to cause the electrophoretic coating to adhere to the inner wall of the component, said protective sleeve having a cylindrical shape in a non-deformed state, with openings extending through a wall of said protective sleeve to allow said electrophoretic coating to contact the anode.
